(19) United States
(12) Patent Application Publication
(10) Pub. No.: US 2002/0060668 A1
(43) Pub. Date: May 23, 2002

(54) Method and apparatus for providing a variable resolution touch pad

(76) Inventor: William James McDermid, Niwot, CO (US)

Correspondence Address: IP PATENTS, FAEGRE & BENSON LLP, 1900 FIFTEENTH STREET, BOULDER, CO, 80302, US

(21) Appl. No.: 09/989,811

(22) Filed: Nov. 20, 2001

Related U.S. Application Data
(63) Continuation of application No. 09/718,800, filed on Nov. 22, 2000.

(51) Int. Cl. G09G 5/00

(52) U.S. Cl. 345/173

(57) ABSTRACT

An apparatus (100) having variable resolution that captures user touch points on a touch pad. Control circuitry in the apparatus (301) detects a touch point on the touch pad, (302) determines a location of the touch point, and (303) adjusts resolution of an area proximate the location of the touch point to detect subsequent touch points.

### CROSS REFERENCE TO A RELATED APPLICATION

This application is a continuation of U.S. patent application Ser. No. 09/718,800 titled “Method and Apparatus for Providing a Variable Resolution Touch Pad” and filed Nov. 22, 2000. The referenced application is hereby incorporated by reference as if the referenced application were included in this application.

### FIELD OF THE INVENTION

This invention relates to a touch pad for capturing images made by user touch strokes. More particularly, this invention relates to a touch pad that detects a first touch point and adjusts the resolution of the defined areas of the touch pad to accurately capture images into the defined areas in greater detail. Still more particularly, this invention relates to an apparatus and a method for determining which area of a touch pad is being used and then adjusting the resolution of a localized area of the touch pad to a level that is needed to capture images in the defined area.

### PROBLEM

It is common to use touch pads to receive information from a user. For example, it is now common for retail stores to have a touch pad that captures a buyer's signature as the buyer moves a stylus over the pad. A second example is a touch pad on a notebook computer that captures images as a user moves a finger across a touch pad. The image is then used to move a cursor across a screen.

The image is captured in the following manner. A first terminal and a second terminal are on top and bottom ends, respectively, of a first conductive layer of a touch-pad while a third and fourth terminal are on the left and right ends, respectively, of a second conductive layer. A voltage is applied between the first and second terminals to set up a voltage gradient down a linearly resistive first conductive layer. A user then touches the pad which causes a connection between the first and the second layer. The voltage potential on the second conductive layer rises to the voltage at the touch-point on the first layer and can be read at the third or fourth terminals of the second layer. The measured voltage gives a first, or a (y) coordinate. The process is then rapidly repeated by applying a voltage between the third and fourth terminals to set up a voltage gradient across the pad on the second conductive layer. The voltage potential on the first conductive layer rises to the voltage at the touch-point on the second layer and can be read at the first or second terminal of the first layer to give a second or an (x) coordinate.

It is a problem that the resolution of the touch pads are the same across the length and width of the conductive pad. Sometimes, the pad is used to capture images where it is more important to capture a more detailed image in one area than in another. For example, a touch pad may be used to complete a form and then have a user sign the form. The completion of the form by checking boxes may not need as high a resolution as is needed to capture the signature.

A second example is the use of a touch pad to record inputs from users such as characters in the Chinese alphabet. As is commonly known, the Chinese alphabet consists of many characters representing many words. Keyboard input for computer systems is impractical for those using the Chinese language. Therefore, the use of a touch pad to capture images drawn by a user is a preferred input method. It is a problem that many characters in the Chinese alphabet are similar. Greater resolution is needed to detect the difference between characters. Thus, it is desirable to be able to detect where on the touch pad that the user is drawing a character and magnify the resolution to increase sensitivity.

### SOLUTION

The above and other problems are solved and an advance in the art is made by a variable resolution touch pad in accordance with this invention. A first advantage of this invention is that the resolution of a defined area of the touch pad may be changed. This allows resolution to decrease and increase in accordance to the image being captured. A second advantage of this invention is that the resolution may be changed in only the defined portion of the touch pad. Thus, the resolution of the area where the user is drawing may be increased to capture a more accurate image. A third advantage of this invention is that as the user moves between areas of the touch pad, the resolution may change. This allows for tasks such as filling out a form in one area and capturing a signature in the other area of the touch pad.

In accordance with this invention, a typical touch pad has a first and a second terminal on first and second opposing ends of one layer of the touch pad. Third and fourth terminals are on third and fourth opposing ends on a second layer. A spacer keeps the two conductive layers separated except at the point were the pad is being touched. There is also circuitry that applies voltages between the opposing terminals of one layer and reads the voltage at the touch point from the terminals of the other layer. This invention relates to the control circuitry which controls the voltage applied across the terminals. The touch pad system in this invention has control circuitry that detects a touch point on the touch pad, determines a location of the touch point, adjusts resolution of area proximate the location of the touch point to detect subsequent touch points.

The control circuitry is also configured to monitor subsequent touch points after the resolution is adjusted. The control circuitry also stores an image created by the subsequent touch points. This captures the image being drawn by the user.

The control circuitry may detect and determine the location of a touch point by detecting a location of a touch point in a first axis of one layer and determine a location of a touch point in a second axis of another layer. This determines the (x) coordinate of the touched point and a (y) coordinate of the touched point.

The control circuitry may also be further configured to determine a proper resolution of the touch pad for the area proximate the location of the touch point. This allows the resolution to depend on the position of the user's touch. The resolution may be less in some areas of the pad and greater in other portions of the touch pad.

The control circuitry may adjust the resolution by changing resolution in a first axis and changing the resolution in a second axis. The resolution is adjusted in this manner by adjusting the voltages at the terminals. The control circuitry monitors a first axis for a first axis location of a subsequent touch point and then monitors a second axis for a second axis location of the subsequent touch point. The control circuitry then stores the first axis location and the second axis location in a memory.

As the user is drawing an image, the user may move to a different location on the touch pad where the resolution may be different. Therefore, the control circuitry is configured to detect a location of a subsequent touch point that is distal from the area proximate the location of the first touch point. The control circuitry then adjusts the resolution for a second area proximate said location of said subsequent touch point.

### ASPECTS OF THE INVENTION

One aspect of the invention is an apparatus for capturing user touch points on a touch pad:

said apparatus comprising:

apparatus for subdividing the touch pad into at least one area of defined size and location:

apparatus for detecting a touch point on said touch pad;

apparatus for determining the location of said detected touch point on said touch pad;

apparatus for selecting to the defined area containing the touch point;

apparatus for setting the resolution of the defined area; and

apparatus for detecting subsequent touch points in said defined area.

Preferably the invention includes further comprising an apparatus for storing an image created by said subsequent touch points.

Preferably said apparatus (401, 402) for detecting and determining detects a location of said touch point in a first axis of said touch pad and determines a location of said touch point in a second axis.

Preferably the invention further comprises an apparatus (404, 405) for adjusting said resolution by controlling the resolution in a first axis and changing the said resolution in a second axis.

Preferably said apparatus for adjusting said resolution in said first axis and said second axis adjusts the voltage potential at a first and a second terminal of said touch pad.

Preferably the invention further comprises apparatus (406) for monitoring a first axis for a first axis location of a subsequent user depression at a touch point.

Preferably the invention further comprises apparatus circuit (407) for monitoring a second axis for a second axis location of said subsequent touch point.

Preferably the invention further comprises apparatus (411) for storing said first axis location and said second axis location in a memory.

Preferably the invention further comprises apparatus (409) for detecting a location of a subsequent touch point that is distal from said area proximate said location of said touch point.

Preferably the invention further comprises apparatus (403) for adjusting resolution for a second area proximate said location of said subsequent touch point.

Another aspect of the invention includes a method for operating a touch pad to detect user touch points, said method comprising the steps of:

subdividing the touch pad into at least one area of a defined size and location:

detecting a touch point;

determining the location of said touch point on said touch pad;

selecting the defined area containing the touch point;

setting the resolution of the defined area; and

detect subsequent touch points in said defined area.

Preferably the invention further comprises the step of:

storing an image represented by said subsequent touch points.

Preferably said steps of detecting and determining said location of said touch points comprise the steps of:

detecting a user depression representing a location of said touch point in a first axis of said touch pad; and

detecting a location of said touch point in a second axis of said touch pad.

Preferably said step of adjusting said resolution comprises the steps of:

controlling the resolution in a first axis of said touch pad; and

controlling said resolution in a second axis of said touch pad.

Preferably said steps of controlling said resolution in said first axis and said second axis comprise the step of:

adjusting voltage potentials applied to first and a second terminals of said touch pad.

Preferably the invention further comprises the step of:

monitoring said first axis location for each said subsequent touch point representing a user depression.

Preferably the invention further comprises the step of:

monitoring a second axis location for each said subsequent touch point.

Preferably the invention wherein subsequent touch point comprises the step of:

storing said first axis location and said second axis location in a memory.

Preferably the invention further comprises the step of:

detecting a subsequent touch point is in a touch pad area distal from said area proximate said location of said touch point.

Preferably the invention further comprises the step of:

adjusting the resolution for a second area of said touch pad proximate said location of said subsequent touch point.

Preferably the invention wherein the position of said defined area on said touch pad is controlled by the steps of:

choosing a signal S1 which is the largest the touch point resolution can process;

further choosing a signal S2 to set the size of the area spanned by S1 on said touch pad;

further choosing signal S3 to set the location of S1 on said touch pad; and

further applying S3 to one side of said touch pad and S3-S2 to the other side of said touch pad so that S1 spans said defined area on said touch pad.

Preferably the invention wherein said signals S1, S3 and S3 are voltage signals V1, V2 and V3.

### BRIEF DESCRIPTION OF THE DRAWINGS

The above and other advantages of this invention are described in the detail description below and the following drawings:

FIG. 1 illustrating a touch pad system;

FIG. 2 illustrating a processing system in control circuitry of a touch pad system;

FIG. 3 illustrating a flow diagram of a process for varying resolution of a touch pad in accordance with this invention; and

FIG. 4 illustrating a flow diagram of a preferred embodiment of a process for varying resolution in accordance with this invention.

### DETAILED DESCRIPTION

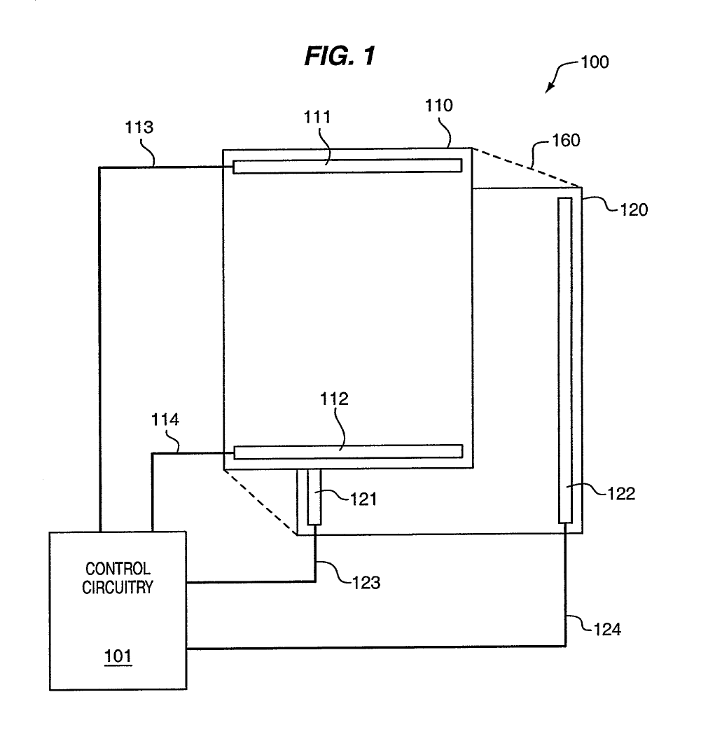

FIG. 1 illustrates a touch pad system 100 embodying the invention. Touch pad system 100 includes control circuitry 101. Control circuitry 101 applies voltage potentials to the terminals on one layer of the touch pad and determines a location of a touch from the measured voltage on the other layer. Control circuitry 101 also performs the processes that are included in this invention.

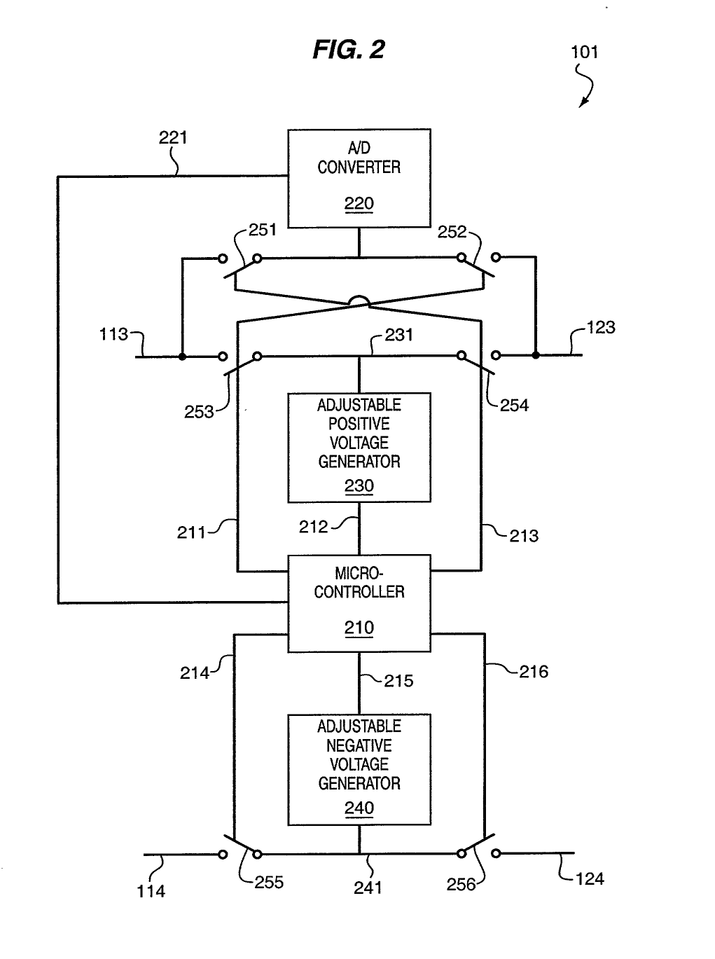

Paths 113 and 114 on FIGS. 1 and 2 connect control circuitry 101 of FIG. 1 to terminals 111 and 112 on the top and bottom ends of layer 110 of pad 160. Path 123 and 124 connect control circuitry 101 to terminals 121 and 122 on the left and right ends of layer 120 of pad 160.

In a touch pad system 100 of the invention, a touch is captured in a following manner. First, control circuitry 101 applies a voltage across first terminal 111 and second terminal 112 to generate a voltage gradient along a linearly resistive layer 110. This is accomplished when microcontroller 210 closes switches 252, 253 and 255. The closure of switch 253 applies a positive potential to path 113 from path 231 and the upper output of adjustable positive voltage generator 213. The closure of switch 255 extends a negative potential from the adjustable negative voltage generator 240 via path 241 and switch 255 to path 114. These potentials on paths 113 and 114 establish the voltage gradient across the touch pad, top layer 110 on FIG. 1. When a user touches conductive pad 160, layer 120 connects to layer 110 at that touch point and the voltage on layer 110 at the touch point can be read at terminal 121 on layer 120. The voltage that is read is extended via path 123 in FIG. 1 to path 123 in FIG. 2 where it is extended through closed contacts 252 to the lower input of A/D Converter 220. Microcontroller 210 receives the digital value generated by A/D converter 220 via interface 221. From this voltage, control circuitry 101 determines a coordinate on the first or (y) axis. The process concludes when microcontroller 210 opens switches 252, 253, and 255.

The process is then repeated. The next step of the sequence is that microcontroller 210 closes switches 251, 254 and 256 extends potentials on paths 231 and 241 to paths 123 and 124 where on FIG. 1 they are connected to terminals 121 and 122 of pad layer 120. This time voltage is applied across third terminal 121 and fourth terminal 122 on layer 120. With contacts 254 and 255 closed, the voltage read at terminal 111 on layer 110 is used to determine a position on the second axis or the (x) coordinate. The voltage is read at this time by terminal 111 extended over path 113 on FIG. 1 to FIG. 2 where it passes through contacts 251 to the lower input of A/D converter 220.

This invention relates to changing the resolution of touch pad system 100. More particularly, this invention relates to changing the resolution in a specific area of touch pad system 100. This invention is accomplished in control circuitry 101. This invention may be practiced using hardware, firmware or software in control circuitry 101.

FIG. 2 illustrates a preferred embodiment of control circuitry 101. Control circuitry 101 includes microcontroller 210. Microcontroller 210 includes internal non-volatile memory to store instructions for applications being executed and Random Access Memory (RAM) to store data for applications being executed. Microcontroller 210 can vary the voltage output by positive voltage generator 230 via control path 212. In a preferred embodiment, the voltage is varied between 5 volts and 25 volts. Likewise, microcontroller 210 can vary the voltage output by negative voltage generator 240 via control line 215. In a preferred embodiment the negative voltage is adjusted from 0 volts to −20 volts. Microcontroller 210 controls switches 253 and 252 via control line 211, switches 254 and 251 via control line 213, switch 255 via control line 214 and switch 256 via control line 216. Microcontroller 210 receives touch pad voltage measurement data from A/D converter 220 via connection 221.

A/D converter 220 reads the voltage on touch pad layer 110 via path 113 when switch 251 is closed and reads the voltage on touch pad layer 120 via path 123 when switch 252 is closed. In a preferred embodiment, A/D converter 220 can only read voltages between 0 and 5 volts so microcontroller 210 must manage adjustable voltage generators 230 and 240 and switches 253-256 to provide a signal between 0 and 5 volts to A/D converter 220.

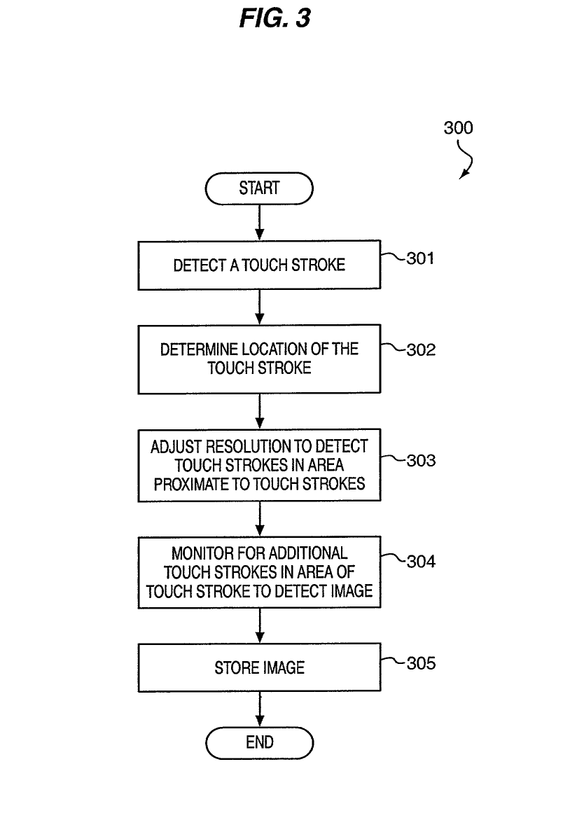

FIG. 3 illustrates a process 300 executed by control circuitry 101 to provide a series of touch points from a touch pad in accordance with this invention. Process 300 begins in step 301 with a touch point being detected. At this time, the touch pad has 5 volts between its top and bottom with the top being at 5 volts and the bottom being at 0 volts. Control circuitry 101 then determines the location of the touch point in step 302. In step 303, control circuitry 101 adjusts the resolution of the touch pad to detect touch points in an area proximate the location of the touch point. This is done by changing the voltages on the terminals of the touch pad. Control circuitry 101 then monitors for additional touch points in the area proximate the location of the touch point in the area of the first touch point in step 304. This is done as A/D converter 220 converts the voltages representative of the touch points that are delivered on paths 113 and 123 and supplies location information in the form of digital values over paths 221 to the microcontroller. Process 300 ends in step 305 with control circuitry 101 storing the image captured from the touch points drawn by the user in a high resolution area of the touch pad. The image is stored in a memory of controller 210.

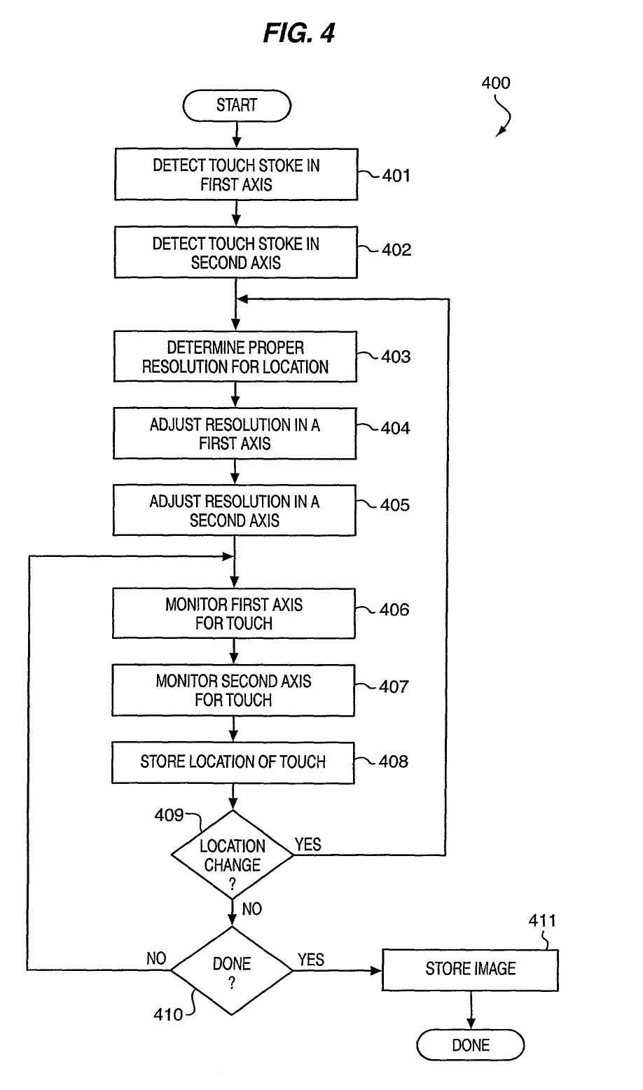

FIG. 4 further details a preferred process 400 for providing a variable resolution touch pad in accordance with this invention. Process 400 is executed by control circuitry 101. Process 400 begins in step 401 when a touch point is detected in the first axis. In a preferred embodiment, this is done by applying a 5 volts potential to terminal 111 and a 0 volts potential to terminal 112 on touch pad layer 110 and reading the voltage at terminal 121. In step 402, control circuitry 101 detects the touch point in a second axis. In a preferred embodiment, this is done by applying a 5 volts potential to terminal 121 and a 0 volts potential to terminal 122 on touch pad layer 120 and reading the voltage at terminal 111. The location of the touch point across the entire touch pad is then determined from the voltage values.

In step 403, control circuitry 101 determines the proper resolution for the area proximate the location of the touch point. This is done by the internal programming of the microcontroller which receives the touch point information and determines the voltages to be applied to the touch pad terminals to adjust the resolution to the desired optimum value. In step 404, control circuitry 101 adjusts the resolution proximate the location of the touch point along a first axis. This is done by controlling the voltage across the entirety of the pad. For example, driving 15 volts at terminal 111 and −10 volts at terminal 112 will create an area in the middle fifth of the pad where the voltage ranges from +5 to 0 volts. This 5 volt difference is the voltage limit of the A/D converter. Let it be assumed that the A/D converter is a 12 bit device and therefore has an output of 4,096 levels which is 212. In current product implementations these 4,096 levels are spread over the entire pad. On the other hand, in accordance with the present invention, the 4,096 levels can be applied to a smaller defined area of the touch pad associated with the 5 volt differential input to the A/D converter. This defined 5 volt location can be anyplace on the touch pad. In the above example it is assumed to be approximately in the middle fifth which occurs when 15 volts is applied to terminal 111 and −10 to terminal 121. If it is desired to make the 5 volt location the top fifth of the touch pad this could be done by altering the voltage across the entire touch pad so that the voltage at terminal 111 is +5 and the voltage at terminal 112 is −20. In this case, the defined 5 volt high resolution area of interest will be at the top of the touch pad and will extend down one fifth of the way to the 0 volt location. In other words, the 5 volt location is defined by the area on the touch pad with 5 volts at the top and 0 volts at the bottom. At a slightly different resolution, the touch pad voltages could be varied so that there is 5 volts at the top, 0 in the middle and −5 at the bottom. In this case, the high resolution area of 5 down to 0 will be at the top half of the touch pad. In step 405, the width of the high resolution area is set. The width is also defined by 5 to 0 volt boundaries on the touch pad. For example, if the width of the high resolution area was to be the right half of the pad, then one would put 10 volts on terminal 121 and 0 volts on terminal 122. By this means, this invention allows one to create a 5 to 0 volt rectangle of any height and any width at any location on the pad.

In step 406, the monitoring process starts on the first axis using the resolution set in step 404. In step 407, touches on the second axis are monitored. The location of the touch is then stored in a memory of microcontroller 210 in step 408.

In step 409 the control circuitry determines whether the location of a monitored touch remains within the 5 to 0 volt defined rectangle or whether it does not. If a new touch by the user is determined to be outside of the rectangle then the process loops back to step 403 which determines the location for the new touch and the desired resolution and the process proceeds as above described. If the new touch is inside the rectangle then step 410 of process 400 determines whether the user is done providing an image. If not, the process repeats from step 406. If so, control circuitry 101 stores the image in step 411 and process 400 ends.

### SUMMARY

In summary of the above, the invention creates touch pad areas of definable sizes and resolution by the steps of:

1. subdividing a touch pad to create at least one area of a defined size and location on the touch pad;

2. detecting a touch point in said touch pad;

3. select the defined area of the touch point;

4. utilizing the full 12 bits of resolution of the A/D converter within the defined area to set the voltages on the terminals of the touch pad;

5. detecting subsequent user touch points in the defined area to generate and store user generated images.

6. The defined areas can be positioned anywhere on the touch pad by controlling the voltages applied to the touch pad. An area, regardless of its size and or location always has a fixed voltage drop across it (such as 5 volts).

At one extreme, the defined area can be the entire touch pad. In this case, the top of the area will be at 5 volts and the bottom of the area will be at 0 volts. The maximum available voltage levels (4,096) will then be applied across the pad to create a lower resolution.

The defined area may be placed at the top one fifth of the pad by applying +5 volts to the top of the screen and −20 volts to the bottom. The top 1/5 of the pad has +5 volts on its top and 0 volts on its bottom. This defined area now has all of the 4,096 voltage levels and thus increased resolution.

In the same manner, the defined area may be located in the middle 1/5 of the pad by applying +15 volts to the top of the pad and −10 volts to the bottom of the pad. The middle area has +5 volts on its top and 0 volts on its bottom. The defined area may be placed on the lower 1/5 of the pad by applying +25 volts to the top of the pad and 0 volts to the bottom of the pad. The defined area, as always, has +5 volts on its top and 0 volts on its bottom. The horizontal boundaries of the defined area may be defined in the same manner using the control voltages. In other words the resolution of an area is determined by the size of the area since each defined area always receives the 4,096 available voltage levels from the A/D. The location of the defined area is controlled by applying +5 and 0 volts across the area while also applying control voltages to the top and bottom of the touch pad to move position the defined area with its +5 volts and 0 volt potential to the desired portion of the touch pad.

It is to be understood that the term “apparatus” as used herein shall be construed broadly to mean mechanical apparatus, semiconductor devices, as well as electrical circuits that are hardware and/or software controlled. The touch pads disclosed herein are of the resistive type and are powered by electrical signals applied to the terminals of each layer. It is to be understood that the present invention may be embodied by any type of touch pad capable of detecting a touch point and generating output information identifying the location of the touch point on the touch pad. Other suitable types of touch pads include capacitive and optical. Further, the term “resolution” shall be construed to mean the relative capability of the touch pad and its associated circuitry to break up closely spaced adjacent touch points into separate signals.

What is claimed:

1. Apparatus 100 for capturing user touch points on a touch pad:
said apparatus comprising:
apparatus 210 for subdividing the touch pad into at least one area of defined size and location:
apparatus 401, 402 for detecting a touch point on said touch pad;
apparatus 302 for determining the location of said detected touch point on said touch pad;
apparatus 403 for selecting to the defined area containing the touch point;
apparatus 404, 405 for setting the resolution of the defined area; and
apparatus 408 for detecting subsequent touch points in said defined area.

2. The apparatus of claim 1 further comprising apparatus 305 for storing an image created by said subsequent touch points.

3. The apparatus of claim 1 wherein said apparatus 401, 402 for detecting and determining detects a location of said touch point in a first axis of said touch pad and determines a location of said touch point in a second axis.

4. The apparatus of claim 1 further comprising apparatus 404, 405 for adjusting said resolution by controlling the resolution in a first axis and changing the said resolution in a second axis.

5. The apparatus of claim 4 wherein said apparatus for adjusting said resolution in said first axis and said second axis is adjusts the voltage potential at a first and a second terminal of said touch pad.

6. The apparatus of claim 4 further comprising apparatus 406 for monitoring a first axis for a first axis location of a subsequent user depression at a touch point.

7. The apparatus of claim 6 further comprising apparatus circuit 407 for monitoring a second axis for a second axis location of said subsequent touch point.

8. The apparatus of claim 7 further comprising apparatus 411 for storing said first axis location and said second axis location in a memory.

9. The apparatus of claim 1 further comprising apparatus 409 for detecting a location of a subsequent touch point that is distal from said area proximate said location of said touch point.

10. The apparatus of claim 9 further comprising apparatus 403 for adjusting resolution for a second area proximate said location of said subsequent touch point.

11. A method for operating a touch pad to detect user touch points, said method comprising the steps of:
subdividing the touch pad into at least one area of a defined size and location:
detecting a touch point;
determining the location of said touch point on said touch pad;
selecting the defined area containing the touch point;
setting the resolution of the defined area; and
detect subsequent touch points in said defined area.

12. The method of claim 11 further comprising the step of:
storing an image represented by said subsequent touch points.

13. The method of claim 11 wherein said steps of detecting and determining said location of said touch points comprise the steps of:
detecting a user depression representing a location of said touch point in a first axis of said touch pad; and
detecting a location of said touch point in a second axis of said touch pad.

14. The method of claim 11 wherein said step of adjusting said resolution comprises the steps of:
controlling the resolution in a first axis of said touch pad; and
controlling said resolution in a second axis of said touch pad.

15. The method of claim 14 wherein said steps of controlling said resolution in said first axis and said second axis comprise the step of:
adjusting voltage potentials applied to first and a second terminals of said touch pad.

16. The method of claim 14 further comprising the step of:
monitoring said first axis location for each said subsequent touch point representing a user depression.

17. The method of claim 14 further comprising the step of:
monitoring a second axis location for each said subsequent touch point.

18. The method of claim 17 further wherein subsequent touch point comprises the step of:
storing said first axis location and said second axis location in a memory.

19. The method of claim 11 further comprising the step of:
detecting a subsequent touch point is in a touch pad area distal from said area proximate said location of said touch point.

20. The method of claim 19 further comprising the step of:
adjusting the resolution for a second area of said touch pad proximate said location of said subsequent touch point.

21. The method of claim 11 wherein the position of said defined area on said touch pad is controlled by the steps of:
choosing a signal S1 which is the largest the touch point resolution detection method can process:
further choosing a signal S2 to set the size of the area spanned by S1 on said touch pad;
further choosing a signal S3 to set the location of S1 on said touch pad; and
further applying S3 to one side of said touch pad and S3-S2 to the other side of said touch pad so that S1 spans said defined area on said touch pad.

22. The method of claim 21 wherein said signals S1, S2 and S3 are voltage signals V1, V2 and V3.
